(19) United States
(12) Patent Application Publication
(10) Pub. No.: US 2019/0113443 A1
(43) Pub. Date: Apr. 18, 2019

(54) MULTI-PASSAGE PHOTOACOUSTIC DEVICE FOR DETECTING GAS

(71) Applicant: COMMISSARIAT A L'ENERGIE ATOMIQUE ET AUX ENERGIES ALTERNATIVES, PARIS (FR)

(72) Inventor: Serge GIDON, LA MURETTE (FR)

(21) Appl. No.: 16/161,682

(22) Filed: Oct. 16, 2018

(30) Foreign Application Priority Data
Oct. 16, 2017 (FR) 1759679

(51) Int. Cl. G01N 21/17; G01N 21/03; G01N 21/39

(52) U.S. Cl. CPC G01N 21/1702; G01N 21/031; G01N 2201/0697; G01N 2021/1704; G01N 2021/391; G01N 21/39

(57) ABSTRACT

A multi-passage photoacoustic device for detecting gas includes a first portion having a stable optical cavity function and having a diameter D and having a concavity with a bend radius R, the diameter D and the bend radius R being such that

$$0 \leq {( 1 - \frac{D}{R} )}^{2} \leq 1 ;$$

a second portion having an acoustic resonator function and having a first end having a first diameter D1 and a second end having a second diameter D2 less than the first diameter D1, the diameter of the second portion decreasing between its first and second ends; an opening for the introduction of a light beam; a gas supply system for introducing a gas to detect; an acoustic detector coupled with the second end of the second portion.

### CROSS REFERENCE TO RELATED APPLICATIONS

This application claims priority to French Patent Application No. 1759679, filed Oct. 16, 2017, the entire content of which is incorporated herein by reference in its entirety.

### FIELD

The technical field of the invention is that of the photoacoustic detection of gas. One aspect of the present invention relates to a multi-passage photoacoustic device for detecting gas. “Multi-passage” device is taken to mean a device having an optical cavity enabling an optical path length strictly greater than the physical length of said optical cavity.

### BACKGROUND

The photoacoustic effect makes it possible to detect elements capable of absorbing light radiation, that is to say typically gases. In a photoacoustic gas detector, a time variable light source, such as a pulsed laser or amplitude or wavelength modulated laser, interacts with a gas to detect. The luminous energy absorbed by the gas to detect is restored in the form of a transitory heating that generates a pressure wave, itself measured by an acoustic detector.

An important parameter is the length of interaction of the light with the gas to detect: if the gas absorbs too little light, it is not possible to be sure that it is present. If on the other hand the gas absorbs too much light, it is not possible to define its concentration with certainty because any concentration above a certain threshold can lead to total absorption.

To maximise light-matter interaction and thereby enable the detection of low gas concentrations, it is notably known to confine the light and the gas to detect in a multi-passage optical cavity, that is to say an optical cavity enabling several passages of a same light beam and thus an optical path length strictly greater than the physical length of said optical cavity.

Multi-passage photoacoustic devices for detecting gas exist, but they are complex laboratory installations: the article “High finesse optical cavity coupled with a quartz-enhanced photoacoustic spectroscopic sensor”, Patimisco et al., Analyst, 2015, 40, pp. 736-743 thus describes the use of a high finesse resonating optical cavity, in which the length of the cavity is precisely controlled in order to have constructive light interferences: the length of such a cavity is exactly a multiple of the half-wavelength of the light source. The alignment and/or dimensioning constraints are considerable in such multi-passage devices, which prevents their miniaturisation.

Mono-passage photoacoustic devices for detecting gas moreover exist, in which the light beam passes a single time in the optical cavity containing the gas to detect. Compared to the dimensioning of the aforementioned multi-passage devices, the dimensioning of such mono-passage devices is facilitated. However, such mono-passage photoacoustic devices have a small length of interaction of the light with the gas to detect, which makes the detection of low concentrations of gas difficult or even impossible.

### SUMMARY

A photoacoustic device for detecting gas is thus sought that enables the detection of low concentrations of gas while having sufficiently relaxed alignment and/or dimensioning constraints to enable its miniaturisation. Within the scope of the present invention, “low concentration” is taken to mean a concentration typically less than 1 ppm (part per million), thus of the order of several ppb (parts per billion), and “miniature device” is taken to mean a device occupying a volume of the order of several cm³.

A first aspect of the invention relates to a multi-passage photoacoustic device for detecting gas comprising:
a first portion having a stable optical cavity function, the first portion having a first closed end, a second open end and a side wall extending between the first and second ends, the first portion having a diameter D and having a concavity with a bend radius R, the diameter D and the bend radius R being such that:

$$0 \leq {( 1 - \frac{D}{R} )}^{2} \leq 1$$

a second portion having an acoustic resonator function, the second portion having a first open end arranged in the extension of the second open end of the first portion and a second open end, the first end having a first diameter D1 and the second end having a second diameter D2 less than the first diameter D1, the diameter of the second portion decreasing between its first and second ends;
an opening for the introduction of a light beam;
a gas supply system for introducing the gas to detect;
an acoustic detector coupled with the second end of the second portion.

In the present application, the terms “optical cavity” and “optical resonator” are employed indiscriminately and the terms “acoustic detector” and “microphone” are employed indiscriminately.

Thanks to an aspect of the invention, a photoacoustic device ensuring a double function of stable optical cavity and acoustic resonator is used. A light beam is introduced into the photoacoustic device and is confined in the first portion having the stable optical cavity function. The light beam remains confined in the first portion and its energy dissipates progressively, mainly through absorption in a gas to detect. To a lesser extent, the energy of the light beam is also dissipated through losses during reflections within the first portion. The device is multi-passage thanks to the stable optical cavity function of the first portion, but the formation of constructive interferences for the light beam is not sought and thus the dimensioning constraints of the device are very relaxed. The second portion having the acoustic resonator function makes it possible, thanks to its shape, to amplify a pressure wave generated by photoacoustic effect. The shape of the second portion having the acoustic resonator function makes it possible to concentrate the sound at its second end. The acoustic detector is coupled to the second end of the second portion in order to detect the pressure wave at the spot where it is the most amplified. The photoacoustic device according to an aspect of the invention beneficially has low alignment constraints in so far as it suffices to introduce the light beam into the device.

Apart from the characteristics that have just been mentioned in the preceding paragraph, the multi-passage photoacoustic device for detecting gas according to a first aspect of the invention may have one or more additional characteristics among the following, considered individually or according to all technically possible combinations thereof:
The second portion has a length L between its first and second ends and the first diameter D1 of the first end is less than the length L.
The second portion has a diameter that decreases continuously between the first diameter D1 of its first end and the second diameter D2 of its second end.
The first end of the first portion is a reflective optic in such a way that the first portion has a folded stable optical cavity function.
The first portion and the second portion are of circular section.
The second portion is of flattened cone shape.
The gas supply system for introducing a gas to detect is at least one vent, each vent being arranged in the second portion in line with a pressure node of an acoustic mode of the acoustic resonator to favour.
The first portion having a stable optical cavity function has a reflection coefficient strictly greater than 95%.
The opening for the introduction of the light beam is arranged in the side wall of the first portion or in the first end of the first portion or at the junction between the side wall and the first end of the first portion or at the junction between the second end of the first portion and the first end of the second portion.
The multi-passage photoacoustic device comprises a second acoustic detector arranged in line with the pressure node of the fundamental acoustic mode of the acoustic resonator.

A second aspect of the invention relates to a method for detecting gas by means of a multi-passage photoacoustic device according to any of the above embodiments, comprising the following steps:
introducing the light beam into the device via the opening;
introducing the gas to detect into the device via the gas supply system;
carrying out a measurement by means of the acoustic detector.

Apart from the characteristics that have just been mentioned in the preceding paragraph, the method for detecting gas by means of the photoacoustic device according to the first aspect of the invention may have one or more additional characteristics among the following, considered individually or according to all technically possible combinations thereof:
the light beam is introduced into the device via the opening with a first angle α1 measured, in a straight section of the first portion passing through the opening, with respect to a diameter of the first portion passing through the opening and/or with a second angle α2 measured, in a plane perpendicular to the straight section and passing through the opening, with respect to the diameter of the first portion passing through the opening, the first and second angles α1, α2 being such that:

$$\frac{d 40}{D} \leq α 1 , α 2 \leq 10 \times \frac{d 40}{D}$$

with d40 the diameter of the opening.

The invention and its different applications will be better understood on reading the description that follows and by examining the figures that accompany it.

### BRIEF DESCRIPTION OF THE FIGURES

The figures are presented for indicative purposes and in no way limit the invention.

FIG. 1a shows a schematic representation of a multi-passage photoacoustic device for detecting gas according to a first embodiment of the invention.

FIG. 1b shows a second schematic representation of a multi-passage photoacoustic device for detecting gas according to the first embodiment of the invention.

FIG. 1c shows a third schematic representation of a multi-passage photoacoustic device for detecting gas according to the first embodiment of the invention.

FIG. 2a shows a schematic representation of a multi-passage photoacoustic device for detecting gas according to a second embodiment of the invention.

FIG. 2b shows a second schematic representation of a multi-passage photoacoustic device for detecting gas according to the second embodiment of the invention.

FIG. 3a is a schematic representation in section of a first portion, having a first geometry, of a multi-passage photoacoustic device for detecting gas according to any of the embodiments of the invention.

FIG. 3b is a schematic representation in section of a first portion, having a second geometry, of a multi-passage photoacoustic device for detecting gas according to any of the embodiments of the invention.

FIG. 3c is a schematic representation in section of a first portion, having a third geometry, of a multi-passage photoacoustic device for detecting gas according to any of the embodiments of the invention.

FIG. 4a schematically shows a first arrangement of an opening for the introduction of a light beam, in a multi-passage photoacoustic device for detecting gas according to any of the embodiments of the invention.

FIG. 4b schematically shows a second arrangement of an opening for the introduction of a light beam, in a multi-passage acoustic device for detecting gas according to any of the embodiments of the invention.

FIG. 4c schematically shows a third arrangement of an opening for the introduction of a light beam, in a multi-passage acoustic device for detecting gas according to any of the embodiments of the invention.

FIG. 4d schematically shows a fourth arrangement of an opening for the introduction of a light beam, in a multi-passage acoustic device for detecting gas according to any of the embodiments of the invention.

FIG. 4e schematically shows a fifth arrangement of an opening for the introduction of a light beam, in a multi-passage acoustic device for detecting gas according to any of the embodiments of the invention.

FIG. 5 shows calculated acoustic resonance modes in a multi-passage photoacoustic device for detecting gas according to an embodiment of the invention.

FIG. 6a shows a digital simulation of the pressure field of the fundamental mode of the photoacoustic device having the acoustic resonance modes of FIG. 5.

FIG. 6b shows a digital simulation of the pressure field of the second harmonic of the photoacoustic device having the acoustic resonance modes of FIG. 5.

FIG. 7a schematically shows a first angle of introduction of the light beam, used in the first, second and third arrangements of FIGS. 4a, 4b and 4c according to an embodiment of the invention.

FIG. 7b schematically shows a second angle of introduction of the light beam, used in the first, second and third arrangements of FIGS. 4a, 4b and 4c according to an embodiment of the invention.

### DETAILED DESCRIPTION

Unless stated otherwise, a same element appearing in different figures has a single reference.

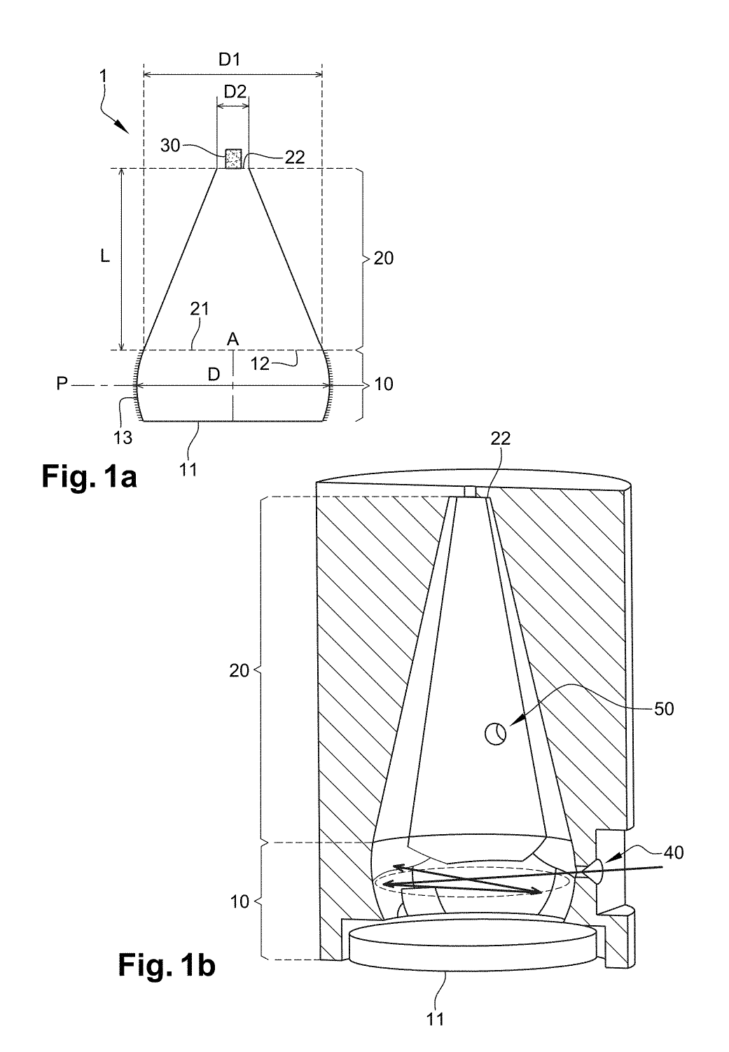

FIG. 1a shows a schematic representation of a multi-passage photoacoustic device 1 for detecting gas, according to a first embodiment of the invention. To be more concise, the multi-passage photoacoustic device 1 for detecting gas according to the first embodiment of the invention will be simply designated “device 1” in the remainder of the description. FIGS. 1b and 1c respectively show second and third schematic representations of the device 1 according to the first embodiment of the invention. FIGS. 1a, 1 b and 1c are described jointly.

The device 1 according to the first embodiment comprises:
a first portion 10 having a stable optical cavity function,
a second portion 20 having an acoustic resonator function,
an opening 40 for the introduction of a light beam,
an acoustic detector 30 for the detection of a pressure wave generated by photoacoustic effect, and
a gas supply system for introducing a gas to detect.

The first portion 10 has a first closed end 11, a second open end 12 and a side wall 13 extending between the first and second ends 11, 12. In order to ensure the stable optical cavity function, the first portion 10 has a diameter D and a concavity with a bend radius R, the diameter D and the bend radius R being such that:

$$0 \leq {( 1 - \frac{D}{R} )}^{2} \leq 1$$

The stable optical cavity has an axis of symmetry A and a plane of symmetry P. The diameter D of the first portion 10 is measured in the plane of symmetry P, perpendicular to the axis of symmetry A. The stable optical cavity has, in an embodiment, a reflection coefficient as high as possible, and at least 95%, in order to contribute to improving the sensitivity of the device 1.

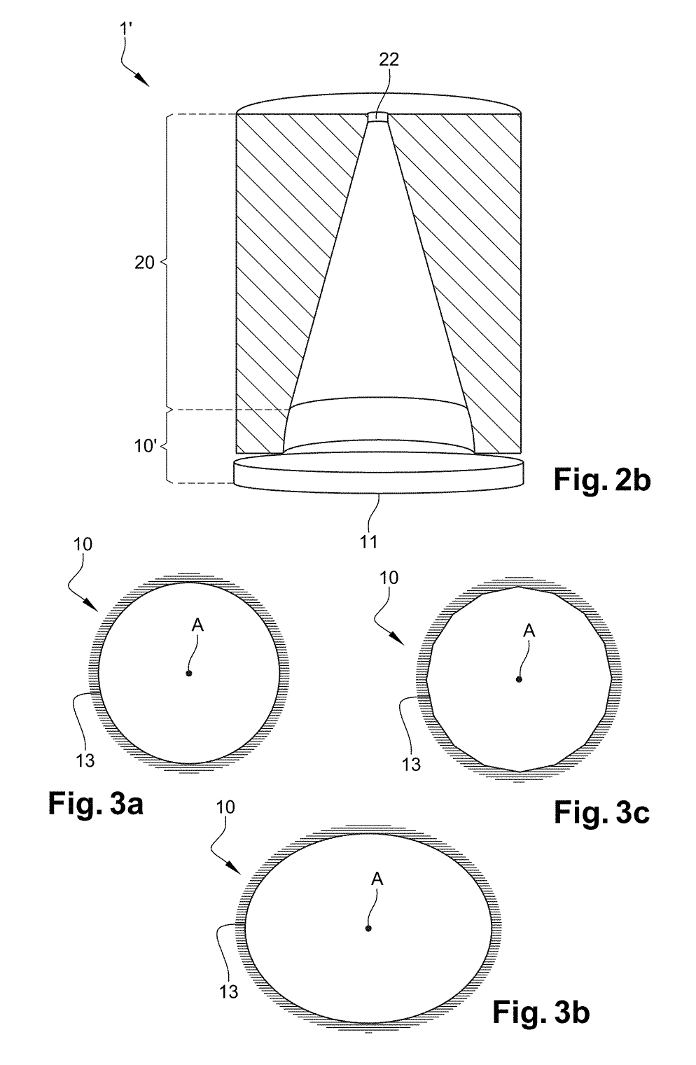

Any section of the first portion 10 through a plane perpendicular to its axis of symmetry A is, in an embodiment, circular, but may also be elliptical or regular polygonal. FIG. 3a schematically shows a section of the first portion 10 through a plane perpendicular to its axis of symmetry A, in the configuration where any section of the first portion 10 through a plane perpendicular to the axis of symmetry A is circular. FIG. 3b schematically shows a section of the first portion 10 through a plane perpendicular to its axis of symmetry A, in an alternative configuration where any section of the first portion 10 through a plane perpendicular to the axis of symmetry A is elliptical. FIG. 3c schematically shows a section of the first portion 10 through a plane perpendicular to its axis of symmetry A, in a second alternative configuration where any section of the first portion 10 through a plane perpendicular to the axis of symmetry A is regular polygonal.

The second portion 20 has a first open end 21, which is arranged in the extension and in the continuity of the second end 12 of the first portion 10, and a second open end 22. The first end 21 of the second portion 20 has a first diameter D1, and the second end 22 of the second portion 20 has a second diameter D2 which is less than the first diameter D1. The first diameter D1 is typically of the order of several centimetres whereas the second diameter D2, linked to the size of the acoustic detector 30, is typically of the order of a fraction of a millimetre. The second portion 20 has a diameter that decreases between its first and second ends 21, 22. The second portion 20 may be defined by extrusion of a substantially circular shape, of which the diameter decreases between the first diameter D1 and the second diameter D2, along a straight or curved generating line, for example a line folded into a U or wound in a spiral. The diameter of the second portion 20 is the maximum dimension in each section perpendicular to the generating line. The diameter of the second portion 20, in an embodiment, decreases continually between its first and second ends 21, 22. According to an alternative, the diameter of the second portion 20 may decrease by stages between its first and second ends 21, 22. In this alternative, the stages are chosen as a function of the acoustic wavelength: the smaller the difference in diameter between two consecutive stages compared to the acoustic wavelength, the less the propagation of the acoustic wave is perturbed. The difference in diameter between two consecutive stages is, in an embodiment, chosen less than or equal to ⅕ of the acoustic wavelength, and, in another embodiment, chosen less than or equal to 1/10 of the acoustic wavelength.

The second portion 20 is, in an embodiment, of flattened cone shape. Alternatively, the second portion 20 may have a folded shape, for example U shaped, or a wound shape, for example a spiral.

The acoustic detector 30, or microphone, may for example be a moveable membrane type detector with a capacitive sensor or piezoelectric strain gauge, or a detector using a diapason technique in which the variation in resonance frequency is detected, or instead a detector using a surface movement detection technique (lever) by optical means.

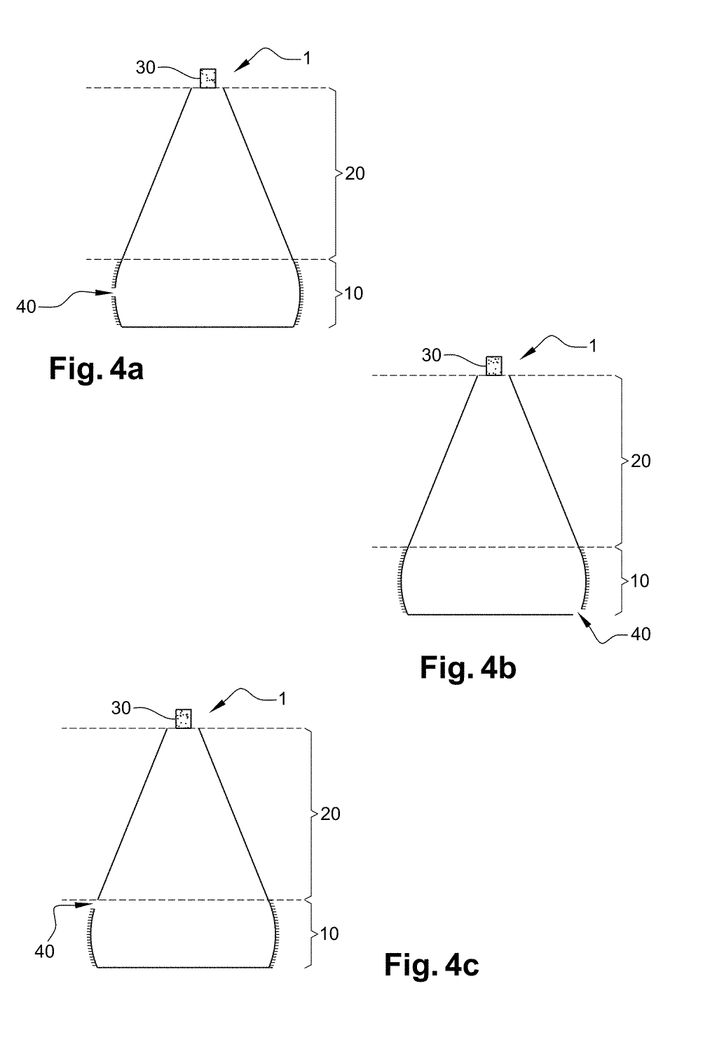

The opening 40 for the introduction of a light beam may be arranged in different manners in the first portion 10 or in the second portion 20. Different arrangements of the opening 40 are described later, in relation with FIGS. 4a to 4e.

By their dimensioning described previously, the first and second portions 10, 20 form an enclosure that resonates at certain frequencies, also called “harmonic modes”. The harmonic mode having the lowest frequency is called “first harmonic” or “fundamental mode”. It is this fundamental mode that it is wished to favour, to the detriment of other harmonics of higher rank. Indeed, benefit is thus made of an excitation frequency of the gas to detect that is as low as possible, better suited to the relaxation time required by the gas after each excitation. The first end 11 of the first portion 10 being closed and the second end 22 of the second portion 20 being able to be considered as closed by the acoustic detector 30, the enclosure formed by the first and second portions 10, 20 behaves like a closed enclosure and the fundamental mode has a stationary pressure field antinode at its two ends and a single stationary pressure field node between its two ends.

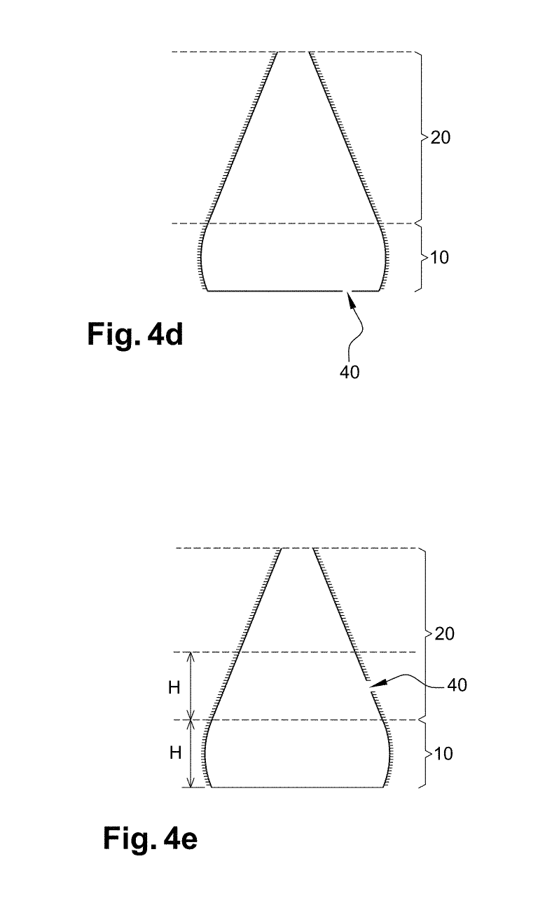

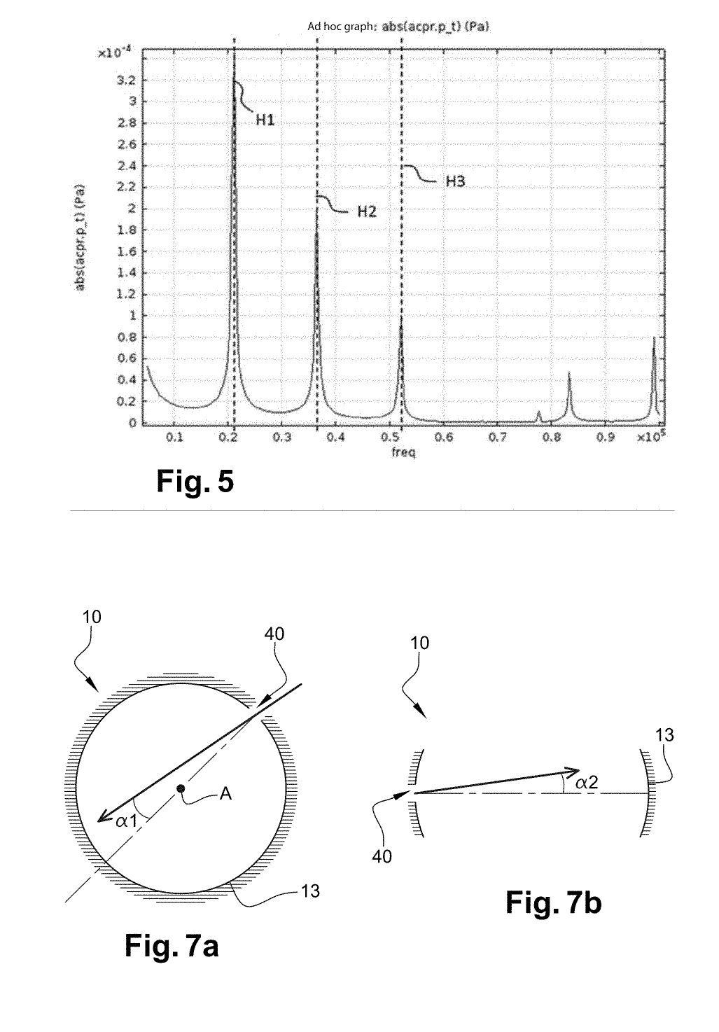

The device 1 comprises a gas supply system for introducing a gas to detect into the enclosure formed by the first and second portions 10, 20. The gas supply system may be a single vent 50 or a plurality of vents 50, for example two vents 50. Each vent 50 is arranged in the second portion 20, for example in line with the stationary pressure field node of the fundamental mode, which contributes to favouring the fundamental mode by not dampening it and by on the contrary dampening potential other harmonic modes. FIG. 5 shows for example acoustic resonance modes, notably the fundamental mode H1, the second harmonic H2 and the third harmonic H3, calculated in an enclosure formed of the first and second portions 10, 20 having the following characteristics: first portion 10 of 10 mm height; second portion 20 of flattened cone shape and 30 mm height. For this enclosure, with the same characteristics, FIG. 6a shows a digital simulation of the pressure field of the fundamental mode H1, and FIG. 6b shows a digital simulation of the pressure field of the second harmonic H2. The fundamental mode H1 of FIG. 6a has a first pressure antinode H1_V1 at the first end of the second portion 20, a second pressure antinode H1_V2 at the second end of the second portion 20 and a pressure node H1_N between the first and second pressure antinodes H1_V1, H1_V2. The second harmonic H2 of FIG. 6b has a first pressure node H2_N1, a second pressure node H2_N2, a first pressure antinode H2_V1 between the first and second pressure nodes H2_N1, H2_N2 and a second pressure antinode H2_V2 at the second end of the second portion 20. The enclosure of FIGS. 6a and 6b comprises first and second vents 50 arranged in line with the pressure node H1_N of the fundamental mode H1. Alternatively, the gas supply system may be a porous wall, for example to better sense emanations from a surface in contact with the porous wall. In this case, it is desirably the first end 11 of the first portion 10 according to the first embodiment of the invention that is a porous wall, in order that the introduction of the gas via the pores of said wall perturbs as little as possible the operation of the acoustic cavity. Within the scope of the present invention, “porous wall” is taken to mean a wall provided with pores of small dimension compared to the acoustic wavelength, that is to say of dimension less than 1/10 of the acoustic wavelength and in an embodiment less than 1/100 of the acoustic wavelength, each pore being distant from the other pores by a distance 3 to 30 times greater than the dimension of the pores. The acoustic wavelength being of the order of a cm, typically comprised between 3 cm and 10 cm, the pores may be of dimensions comprised between 0.3 mm and 1 cm. In comparison, each vent 50 is in an embodiment of millimetric size, notably in order to protect the enclosure from potential external sound pollution. It will thus be understood that according to the given definition, a pore is not necessarily of smaller dimension than a vent.

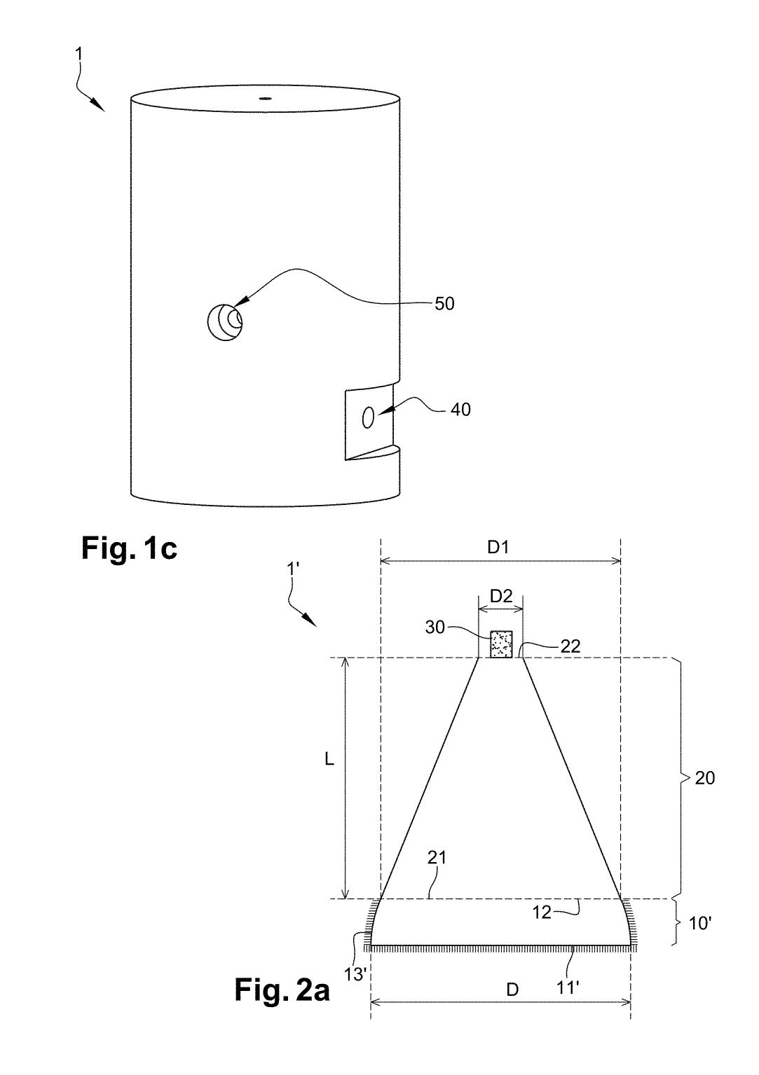

FIG. 2a shows a schematic representation of a multi-passage photoacoustic device for detecting gas 1′, according to a second embodiment of the invention. To be more concise, the multi-passage photoacoustic device 1′ for detecting gas according to the second embodiment of the invention will be simply designated “device 1′” in the remainder of the description. FIG. 2b shows a second schematic representation of the device 1′ according to the second embodiment of the invention.

FIGS. 2a and 2b are described jointly.

The device 1′ according to the second embodiment of the invention comprises:
a first portion 10′ having a folded stable optical cavity function,
the second portion 20 having the acoustic resonator function,
the opening 40 for the introduction of a light beam, and
the acoustic detector 30 for the detection of a pressure wave generated by photoacoustic effect.

The second portion 20, the acoustic detector 30 and the opening 40 of the device 1′ according to the second embodiment of the invention have been described previously for the device 1 according to the first embodiment of the invention.

The first portion 10′ having a folded stable optical cavity function has a first closed end 11′, the second open end 12 and a side wall 13′ extending between the first and second ends 11′, 12. Just like the stable optical cavity of the first portion 10 according to the first embodiment, the folded stable optical cavity of the first portion 10′ according to the second embodiment has the axis of symmetry A and the plane of symmetry P. In order to ensure the folded stable optical cavity function, the first end 11′ is a reflective optic arranged in the plane of symmetry P. The device 1′ according to the second embodiment of the invention, of which the first portion 10′ fulfils the folded stable optical cavity function, may beneficially be manufactured by moulding without draw taper difficulty.

Different arrangements of the opening 40 will now be described, in relation with FIGS. 4a to 4e.

FIG. 4a schematically shows a first example according to which the opening 40 is arranged in the side wall 13 of the first portion 10 according to the first embodiment. The opening 40 may likewise be arranged in the side wall 13′ of the first portion 10′ according to the second embodiment.

FIG. 4b schematically shows a second example according to which the opening 40 is arranged at the junction between the first end 11 and the side wall 13 of the first portion 10 according to the first embodiment. The opening 40 may likewise be arranged at the junction between the first end 11′ and the side wall 13′ of the first portion 10′ according to the second embodiment.

FIG. 4c schematically shows a third example according to which the opening 40 is arranged at the junction between the side wall 13 and the second end 12 of the first portion 10 according to the first embodiment. The opening 40 may likewise be arranged at the junction between the side wall 13′ and the second end 12 of the first portion 10′ according to the second embodiment.

FIG. 4d schematically shows a fourth example according to which the opening 40 is arranged in the first end 11 of the first portion 10 according to the first embodiment of the invention. The opening 40 may likewise be arranged in the first end 11′ of the first portion 10′ according to the second embodiment of the invention.

FIG. 4e schematically shows a fifth example according to which the opening 40 is arranged in a zone of the second portion 20 of the device 1 according to the first embodiment, the zone extending over a length H from the first end 21 of the second portion 20, the length H being equal to the height of the stable optical cavity, that is to say to the height of the first portion 10, measured along the axis of symmetry A. The opening 40 may likewise be arranged in a zone of the second portion 20 of the device 1′ according to the second embodiment, the zone extending over the length H from the first end 21 of the second portion 20, the length H being equal to the height of the folded stable optical cavity, that is to say double the height of the first portion 10′, measured along the axis of symmetry A.

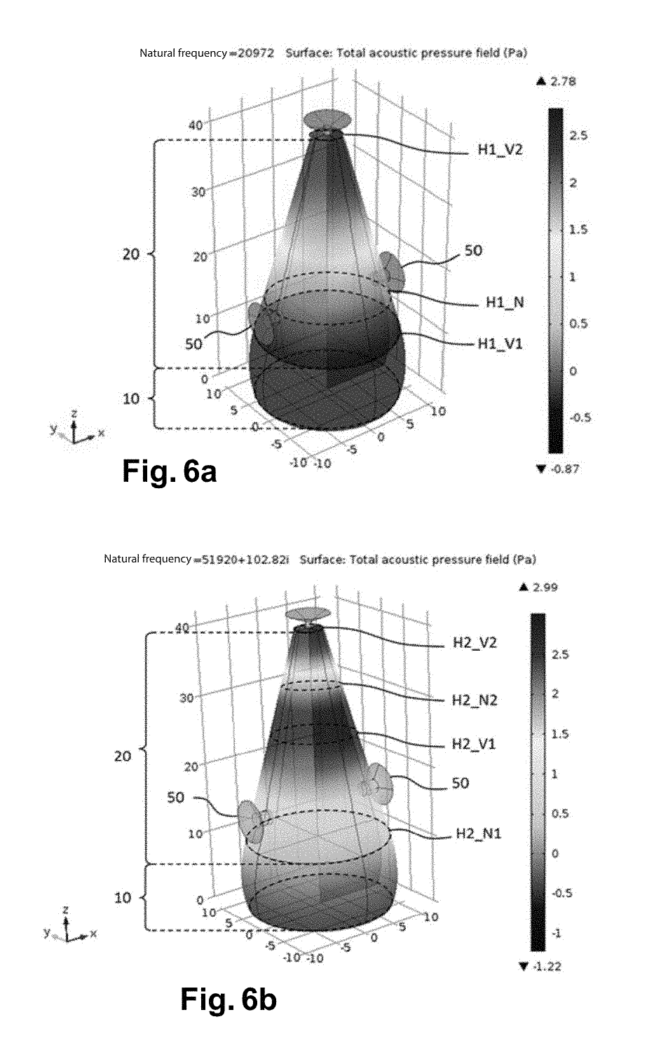

In order to avoid that the light beam does not come out via the opening 40 and in order to maximise the optical path covered by the light beam within the optical cavity, notably in the first, second and third examples of FIGS. 4a, 4b and 4c, the light beam is in an embodiment introduced via the opening 40 with a first angle α1 or with a second angle α2 or both with the first and second angles α1 and α2. The first angle α1, represented in FIG. 7a, is measured, in a straight section of the first portion 10 passing through the opening 40, with respect to a diameter of the first portion 10 passing through the opening 40. The second angle α2, represented in FIG. 7b, is measured, in a plane perpendicular to the straight section defined previously and passing through the opening 40, with respect to the diameter of the first portion 10 passing through the opening 40. The first angle α1 and the second angle α2 are in an embodiment small, that is to say such that:

$$\frac{d 40}{D} \leq α 1 , α 2 \leq 10 \times \frac{d 40}{D}$$

FIGS. 4a, 4b and 4c show that only the first portion 10 has a reflective wall and plays the role of an optical cavity. However, in the first, second and third examples of FIGS. 4a, 4b and 4c, the second portion 20 could alternatively also have a reflective wall, for example at least on a zone extending over the length H from the first end 21 of the second portion 20. FIGS. 4d and 4e show that, in addition to the first portion 10, the entire second portion 20 has a reflective wall and plays the role of an optical cavity. However, in the fourth and fifth examples of FIGS. 4d and 4e, the second portion 20 could alternatively have a reflective wall occupying only a zone extending over the length H from the first end 21 of the second portion 20.

1. A multi-passage photoacoustic device for detecting gas comprising:
a first portion having a stable optical cavity function, the first portion having a first closed end, a second open end and a side wall extending between the first and second ends, the first portion having a diameter D and having a concavity with a bend radius R, the diameter D and the bend radius R being such that:
$$0 \leq {( 1 - \frac{D}{R} )}^{2} \leq 1$$
a second portion having an acoustic resonator function, the second portion having a first open end arranged in the extension of the second open end of the first portion and a second open end, the first end having a first diameter D1 and the second end having a second diameter D2 less than the first diameter D1, the diameter of the second portion decreasing between its first and second ends;
an opening for the introduction of a light beam;
a gas supply system for introducing a gas to detect;
an acoustic detector coupled with the second end of the second portion.

2. The multi-passage photoacoustic device according to claim 1, wherein the second portion has a length L between its first and second ends and wherein the first diameter D1 of the first end is less than the length L.

3. The multi-passage photoacoustic device according to claim 1, wherein the second portion has a diameter that decreases continuously between the first diameter D1 of its first end and the second diameter D2 of its second end.

4. The multi-passage photoacoustic device according to claim 1, wherein the first end of the first portion is a reflective optic in such a way that the first portion has a folded stable optical cavity function.

5. The multi-passage photoacoustic device according to claim 1, wherein the first portion and the second portion are of circular section.

6. The multi-passage photoacoustic device according to claim 16, wherein the second portion is of flattened cone shape.

7. The multi-passage photoacoustic device according to claim 1, wherein the gas supply system for introducing a gas to detect is at least one vent, each vent being arranged in the second portion in line with a pressure node of an acoustic mode of the acoustic resonator to favour.

8. The multi-passage photoacoustic device according to claim 1, wherein the first portion having a stable optical cavity function has a reflection coefficient strictly greater than 95%.

9. The multi-passage photoacoustic device according to claim 1, wherein the opening for the introduction of the light beam is arranged in the side wall of the first portion or in the first end of the first portion or at the junction between the side wall and the first end of the first portion or at the junction between the second end of the first portion and the first end of the second portion.

10. The multi-passage photoacoustic device according to claim 1, further comprising a second acoustic detector arranged in line with the pressure node of the fundamental acoustic mode of the acoustic resonator.

11. A method for detecting gas with a multi-passage photoacoustic device according to claim 1, comprising:
introducing the light beam into the device via the opening;
introducing the gas to detect into the device via the gas supply system;
carrying out a measurement with the multi-passage photoacoustic detector.

12. The method for detecting gas according to claim 11, wherein the light beam is introduced into the device via the opening with a first angle α1 measured, in a straight section of the first portion passing through the opening, with respect to a diameter of the first portion passing through the opening and/or with a second angle α2 measured, in a plane perpendicular to said straight section and passing through the opening, with respect to the diameter of the first portion passing through the opening, the first and second angles α1, α2 being such that:
$$\frac{d 40}{D} \leq α 1 , α 2 \leq 10 \times \frac{d 40}{D}$$
with d40 the diameter of the opening.
